(19) United States
(12) Patent Application Publication
(10) Pub. No.: US 2009/0194515 A1
(43) Pub. Date: Aug. 6, 2009

(54) Air jet type laser processing machine

(75) Inventors: Chia-Lung Kuo, Yunlin County (TW); Yan-Hua Chen, Tainan City (TW); Shih-Min Chen, Hsinchu City (TW)

Correspondence Address: BACON & THOMAS, PLLC, 625 SLATERS LANE, FOURTH FLOOR, ALEXANDRIA, VA, 22314-1176, US

(73) Assignee: CONTREL TECHNOLOGY CO., LTD., TAINAN COUNTY (TW)

(21) Appl. No.: 12/155,872

(22) Filed: Jun. 11, 2008

(30) Foreign Application Priority Data
Feb. 1, 2008 (TW) 97104044

(51) Int. Cl. B23K 26/14

(52) U.S. Cl. 219/121.67

(57) ABSTRACT

An air jet type laser processing machine for processing a workpiece is disclosed to include a gas supply device, a fluid supply device, a recycling device, an actuator, which has an outer tube attached with the bottom end thereof to the surface of the workpiece and defining therein a first passage for guiding discharged gas from the gas supply device to the workpiece, a second passage (or a number of second passages) for guiding the fluid from the fluid supply device to the workpiece and a third passage connected to the recycling device for enabling the recycling device to recycle the discharged gas and fluid, and a laser emitter adapted for emitting a laser beam through the first passage onto the workpiece. During operation, the laser beam and the fluid work on the workpiece at the same time, and the laser beam is free from the interference of the fluid.

### BACKGROUND OF THE INVENTION

1. Field of the Invention

The present invention relates to processing machines and more particularly, to an air jet type laser processing machine.

2. Description of the Related Art

FIG. 5 illustrates a water jet type processing machine that utilizes a high-pressure source to force a flow of water out of the machine, forming a water column 71, i.e., the so-called water jet. By means of changing the impact position to process the workpiece 79, the workpiece 79 is cut subject to the desired size.

However, the water may splash over the surface of the workpiece 79 when moving the open type high-pressure water column 71 to cut the workpiece 79. Therefore, a further cleaning and drying procedure is necessary after the workpiece 79 has been well cut. This cleaning and drying procedure complicates the processing work, increasing the processing time and manufacturing cost. Further, the splashing water may carry cut chips 73 of the workpiece 79, causing damage to the surface of the workpiece 79. In case cut chips 73 fall to grooves or recessed portions on the surface of the workpiece, they may cause accidental injuries. A protection film may be covered on the workpiece 79 before processing and than removed from the workpiece 79 after processing. The use of a protection film avoids damage of cut chips 73 to the surface of the workpiece 79, however it complicates the processing procedure and relatively increases the manufacturing cost.

Further, when a liquid is used with a laser beam to process a workpiece, the liquid may interfere with the laser beam or absorb the energy of the laser beam (such as CO₂ laser beam), lowering the power acted on the workpiece.

### SUMMARY OF THE INVENTION

The present invention has been accomplished under the circumstances in view. It is the main object of the present invention to provide an air jet type laser processing machine, which employs a laser beam and a fluid (gas or liquid, or mixture of gas and liquid) to work the workpiece at the same time, accelerating the processing speed.

It is another object of the present invention to provide an air jet type laser processing machine, which recycles the discharged gas and fluid, avoiding splashing of the fluid and surface damage of the workpiece by the cut chips.

It is still another object of the present invention to provide an air jet type laser processing machine, which enables the laser beam to go through the discharging gas without through the discharging fluid, keeping the laser beam free from the interference of the fluid.

To achieve these and other objects of the present invention, the air jet type laser processing machine for processing a workpiece comprises a gas supply device adapted for outputting a fluid of a gas, a fluid supply device adapted for outputting a flow of a fluid, a recycling device adapted for recycling the gas and fluid discharged by the gas supply device and the fluid supply device, an actuator, which comprises an outer tube that has its bottom end approaching the workpiece and defines therein a first passage, at least one second passage and a third passage respectively axially extending to the bottom end, the first passage having the top end thereof connected to the gas supply device, each second passage having the top end thereof connected to the fluid supply device, the third passage having the top end thereof connected to the recycling device, and a laser emitter adapted for emitting a laser beam through the first passage onto the workpiece. The gas outputted by the gas supply device goes out of the bottom end of the first passage. The fluid outputted by the fluid supply device goes out of the bottom end of each second passage. The recycling device recycles the gas and fluid that going out of the bottom end of the first passage and the bottom end of each second passage by means of the third passage. Therefore, the laser beam and the fluid simultaneously work on the workpiece, and the laser beam is free from the interference of the fluid.

### BRIEF DESCRIPTION OF THE DRAWING

FIG. 1 is an elevational view showing an air jet type laser processing machine attached to the surface of a workpiece according to a first embodiment of the present invention.

FIG. 2 is a schematic structural view of the air jet type laser processing machine in accordance with the first embodiment of the present invention.

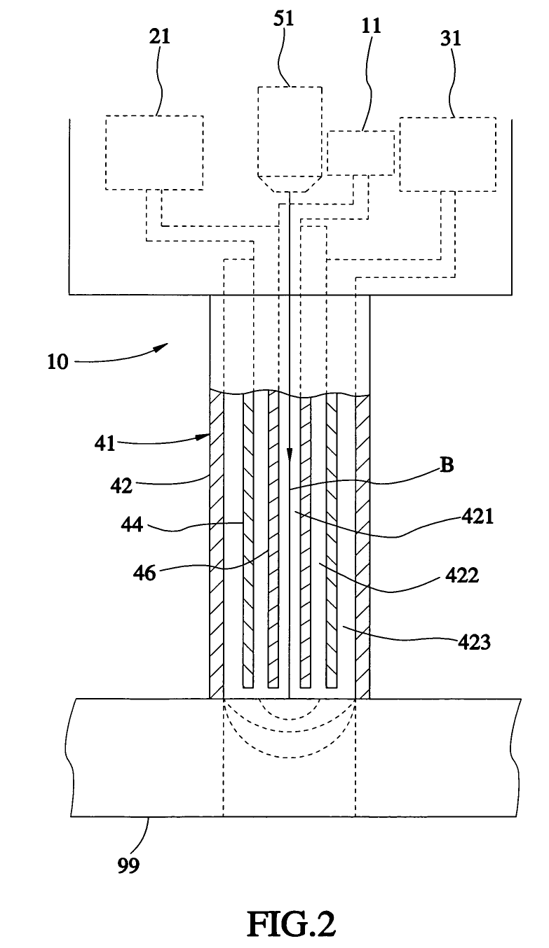

FIG. 3 is an oblique bottom elevation of the bottom end of the air jet type laser processing machine in accordance with the first embodiment of the present invention.

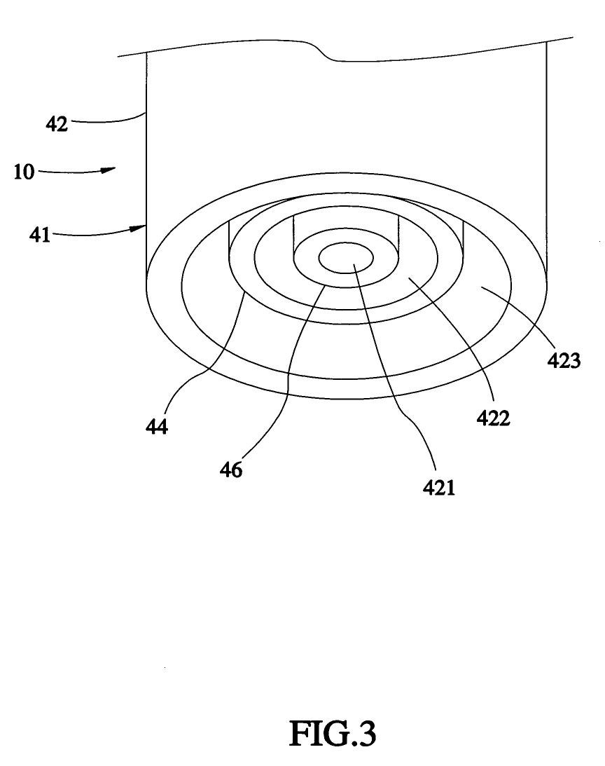

FIG. 4 is an oblique bottom elevation of a bottom end of an air jet type laser processing machine in accordance with a second embodiment of the present invention.

FIG. 5 is a schematic drawing showing a processing operation of a conventional water jet processing machine.

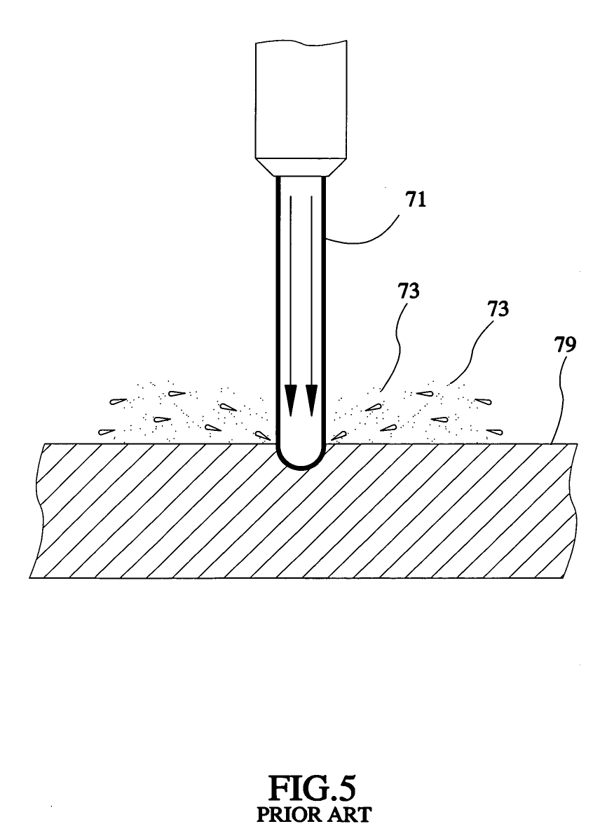

### DETAILED DESCRIPTION OF THE INVENTION

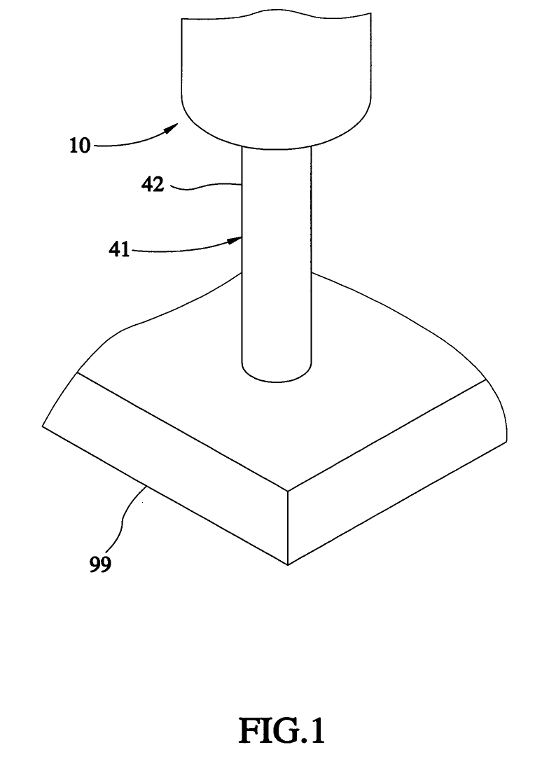

Referring to FIGS. 1˜3, an air jet type laser processing machine 10 in accordance with a first embodiment of the present invention is shown for processing a workpiece 99. The air jet type laser processing machine 10 comprises a gas supply device 11, a fluid supply device 21, a recycling device 31, an actuator 41, and a laser emitter 51.

The gas supply device 11 is adapted for providing a gas.

The fluid supply device 21 is adapted for providing a flow of a fluid (liquid, gas, or mixture of liquid and gas). The liquid can be one of the groups composing of sulfuric acid, hydrochloric acid, sodium nitrate, sodium hydroxide, potassium hydroxide, or hydrofluoric acid. The gas can be regular air.

The recycling device 31 is adapted for recycling the discharged gas and fluid.

The actuator 41 comprises an outer tube 42 adapted for approaching the workpiece 99 with the bottom end thereof, and a plurality of passages including a first passage 421, a second passage 422 and a third passage 423 defined in the outer tube 42. The first passage 421 has its top end connected to the gas supply device 11. The second passage 422 has its top end connected to the fluid supply device 21. The third passage 423 has its top end connected to the recycling device 31. According to this embodiment, the actuator 41 further comprises an intermediate tube 44 axially suspending in the outer tube 42, and an inner tube 46 axially suspending in the intermediate tube 44. The first passage 421 is axially defined in the inner tube 46. The second passage 422 is defined between the outside wall of the inner tube 46 and the inside wall of the intermediate tube 44. The third passage 423 is defined between the outside wall of the intermediate tube 44 and the inside wall of the outer tube 42. The intermediate tube 44 and the inner tube 46 have the respective bottom ends disposed above the elevation of the bottom end of the outer tube 42.

The laser generator 51 is adapted for emitting a laser beam B through the first passage 421 onto the workpiece 99 to process the workpiece 99.

By means of the aforesaid arrangement, the gas provided by the gas supply device 11 goes out of the bottom end of the first passage 421, the fluid provided by the fluid supply device 21 goes out of the bottom end of the second passage 422, and the recycling device 31 recycles the discharged gas and fluid from the bottom end of the third passage 423.

The operation of the air jet type laser processing machine 10 is outlined hereinafter.

When in use, the bottom end of the outer tube 42 is attached to (or kept in proximity to) the surface of the workpiece 99 and then moved relative to the surface of the workpiece 99 subject to a predetermined path. The laser beam B emitted by the laser emitter 51 goes through the first passage 421 to work on the surface of the workpiece 99. The gas provided by the gas supply device 11 is discharged out of the bottom end of the first passage 421. The fluid provided by the fluid supply device 21 is discharged out of the bottom end of the second passage 422. At this time, the discharging force of the continuously discharging gas through the first passage 421 forces the continuously discharging fluid away from the first passage 421. The recycling device 31 provides a suction force to suck the discharged gas and fluid into the third passage 423 for recycling by the recycling device 31. Further, during movement of the actuator 41 relative to the surface of the workpiece 99 and laser processing of the laser beam B on the surface of the workpiece 99, the continuously discharging fluid cools down the surface temperature of the workpiece 99.

Because the laser beam B and the gas provided by the gas supply device 11 share the first passage 421 and because the fluid provided by the fluid supply device 21 is prohibited from entering the first passage 421, the fluid provided by the fluid supply device 21 does not interfere with the laser beam B. When recycling the discharged gas and fluid, cut chips of the workpiece 99 are simultaneously recycled with the discharged gas and fluid by the recycling device 31, avoiding surface damage of the workpiece 99 by the cut chips. Further, because the fluid and the laser beam are simultaneously acted upon the workpiece, the processing speed can be accelerated. Further, because the bottom end of the inner tube 46 and the bottom end of the intermediate tube 44 are disposed above the elevation of the bottom end of the outer tube 42, there is a room within the outer tube 42 below the bottom end of the inner tube 46 and the bottom end of the intermediate tube 44 for movement of the discharged fluid and gas, facilitating recycling of the discharged fluid and gas.

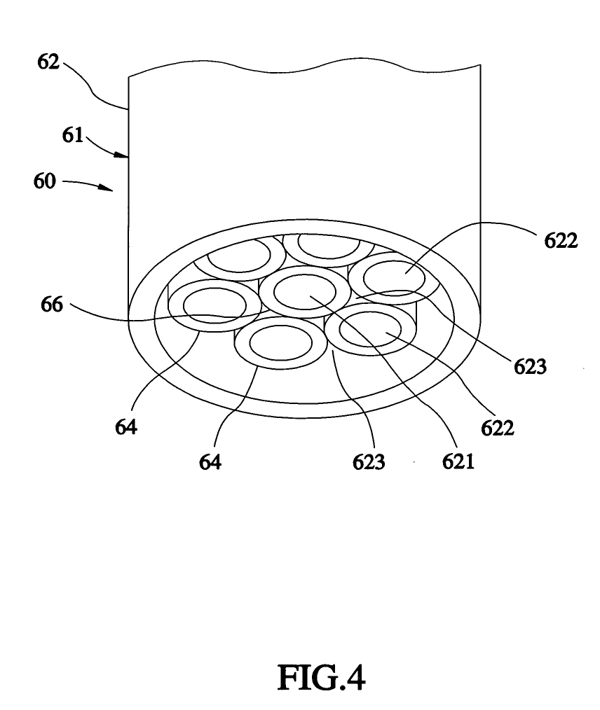

FIG. 4 illustrates an air jet type laser processing machine 60 in accordance with a second embodiment of the present invention. This second embodiment is substantially similar to the aforesaid first embodiment with the exception that:

The actuator 61 of this second embodiment comprises an outer tube 62, an inner center tube 66 axially suspending in the outer tube 62, and a plurality of satellite tubes 64 axially arranged within the outer tube 62 and equiangularly spaced around the periphery of the inner center tube 66. The inner center tube 66 defines a first passage 621. Each satellite tube 64 defines one respective second passage 622. Further, a third passage 623 is defined within the outer tube 62 outside the inner center tube 66 and the satellite tubes 64. Further, the inner center tube 66 and the satellite tubes 64 have the respective bottom ends disposed at an elevation above the bottom end of the outer tube 62.

By means of the aforesaid arrangement, the first passage 621, the second passage 622 and the third passage 623 are provided for the passing of the discharged gas and the fluid and for the recycling of the discharged gas and fluid respectively.

The other structure of this second embodiment and its operation are same as the aforesaid first embodiment, and therefore no further detailed description in this regard is necessary.

As stated above, the invention provides an air jet type laser processing machine, which has the following features and advantages:

1. Simultaneous working of laser and fluid: By means of the design of the present invention, a laser beam and a fluid are provided to work on the workpiece at the same time, accelerating the processing speed and rising productivity.

2. Workpiece protection: By means of the design of the present invention, the discharged gas and fluid are recycled and, cut chips of the workpiece are simultaneously recycled with the discharged gas and fluid by the recycling device, avoiding splashing of the fluid (liquid or gas) and surface damage of the workpiece by the cut chips.

3. Laser free from interference of fluid: By means of the design of the present invention, the discharging force of the continuously discharging gas through the first passage forces the continuously discharging fluid away from the first passage, i.e., there is no any fluid in the first passage as the laser beam is going through the first passage to process the workpiece, and the fluid goes through the area outside the inner tube (or inner center tube), and therefore the laser beam is free from the interference of the fluid. This feature allows application of a relatively cheaper laser beam (for example, CO₂ laser beam).

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An air jet type laser processing machine for processing a workpiece, comprising:
a gas supply device adapted for outputting a flow of a gas;
a fluid supply device adapted for outputting a flow of a fluid;
a recycling device adapted for recycling the gas and fluid discharged by said gas supply device and said fluid supply device;
an actuator, said actuator comprising an outer tube, said outer tube having a bottom end approaching said workpiece, said outer tube defining therein a first passage, at least one second passage and a third passage respectively extending to the bottom end thereof, said first passage and said at least one second passage and said third passage each having a top end and a bottom end, said first passage having the top end thereof connected to said gas supply device, each said second passage having the top end thereof connected to said fluid supply device, said third passage having the top end thereof connected to said recycling device; and
a laser emitter adapted for emitting a laser beam through said first passage onto said workpiece;
wherein the gas outputted by said gas supply device goes out of the bottom end of said first passage; the fluid outputted by said fluid supply device goes out of the bottom end of each said second passage; said recycling device recycles the gas and fluid that going out of the bottom end of said first passage and the bottom end of each said second passage by means of said third passage.

2. The air jet type laser processing machine as claimed in claim 1, wherein said actuator further comprises an intermediate tube axially suspending in said outer tube and an inner tube axially suspending in said intermediate tube; said first passage is axially defined in said inner tube; said at least one second passage is axially defined within said intermediate tube and outside said inner tube; said third passage is axially defined within said outer tube and outside said intermediate tube.

3. The air jet type laser processing machine as claimed in claim 2, wherein said intermediate tube and said inner tube have a respective bottom end disposed above the elevation of the bottom end of said outer tube.

4. The air jet type laser processing machine as claimed in claim 1, wherein said actuator further comprises an inner center tube axially suspending in said outer tube and a plurality of satellite tubes axially suspending in said outer tube and outside said inner center tube; said first passage is axially defined in said inner center tube; said at least one second passage is respectively axially defined is each said satellite tube; said second passage is axially defined within said outer tube and outside said satellite tubes.

5. The air jet type laser processing machine as claimed in claim 4, wherein said inner center tube and said satellite tubes each have a bottom end disposed above the elevation of the bottom end of said outer tube.

6. The air jet type laser processing machine as claimed in claim 4, wherein said satellite tubes are equiangularly spaced around the periphery of said inner center tube.
